(19) United States
(12) Patent Application Publication
(10) Pub. No.: US 2017/0116793 A1
(43) Pub. Date: Apr. 27, 2017

(54) METHOD FOR GENERATING VEHICLE HEALTH PARAMETERS, METHOD FOR DISPLAYING VEHICLE HEALTH PARAMETERS AND DEVICES THEREOF

(71) Applicant: Leauto Intelligent Technology (BEIJING) Co., Ltd., Beijing (CN)

(72) Inventors: Wei Lin, Beijing (CN); Kunsheng Chen, Beijing (CN); Peng Liu, Beijing (CN); Wenrui Li, Beijing (CN); Yong Xu, Beijing (CN)

(21) Appl. No.: 14/960,327

(22) Filed: Dec. 4, 2015

(30) Foreign Application Priority Data
Oct. 21, 2015 (CN) 201510689527.4

(51) Int. Cl. G07C 5/08; G07C 5/00; G07C 5/02

(52) U.S. Cl. CPC G07C 5/0808; G07C 5/02; G07C 5/008

(57) ABSTRACT

There is provided a method for generating vehicle health parameter, a method for displaying vehicle health parameter and the devices thereof, the method for generating vehicle health parameter comprising: obtaining an original vehicle data package from a vehicle cloud data server, the original vehicle data package including vehicle data, the vehicle data including data field; determining a health parameter type which the vehicle data belongs to according to the data field; using the vehicle data under the health parameter type respectively to generate an independent health parameter; using the independent health parameter to generate a comprehensive health parameter. The embodiment of the present disclosure can reflect the health state of the vehicle objectively and accurately.

### CROSS-REFERENCE TO RELATED APPLICATIONS

The present disclosure is based upon and claims priority to Chinese Patent Application No. CN201510689527.4 filed Oct. 21, 2015, the entire contents of all of which are incorporated herein by reference.

### TECHNICAL FIELD

The present disclosure relates to technical field of internet technology and, particularly, to a method for generating a vehicle health parameter and the device thereof, and a method for displaying a health parameter and the device thereof.

### BACKGROUND

In China, used car market situation refers to a primary stage of the used vehicle market. With the further development of China vehicle market this year, new vehicle ownership increases continuously, users show obvious car replacement requirement. In the future, the gap between used vehicle transaction and new vehicle sales will be further reduced. The development of used vehicle market is promising.

Compared with new vehicle market, the used vehicle market is relatively more complex. To new users of vehicle, especially those do not know vehicle well, they are possible to be confused by a plurality of technical parameters and thusly have difficulty in selecting vehicles, which also reflects technical complexity of vehicle itself. Branding management of vehicle manufacturer is benefit for guarantee quality uniformity of new vehicles, and help consumers to know market positioning of each type of vehicle. The used vehicle market is complex is not only because the used vehicle has technical complexity as new vehicle, but also because the using conditions of the used vehicles used by their sellers have great difference between each other. As a result, the vehicle conditions are different even if two vehicles have same vehicle type and same used time. Thusly, the used vehicle market is more complex than new vehicle market.

Currently, apart from the strong demand to vehicle health condition of the used vehicle market, a normal car owner also wishes to know the potential “sickness” or “sub-healthy” state of his or her vehicle at any time. As a result, it is significant to accurately evaluate vehicle health state.

### SUMMARY

An embodiment of the present disclosure discloses a method for generating a vehicle health parameter and the device thereof, and a method for displaying a vehicle health parameter and the device thereof, to solve the problem that currently it is unable to know the vehicle health state accurately.

An embodiment of the present disclosure discloses a method for generating vehicle health parameter, including:

obtaining an original vehicle data package from a vehicle cloud data server, the original vehicle data package including vehicle data, the vehicle data including data field;

determining a health parameter type which the vehicle data belongs to according to the data field;

using the vehicle data under the health parameter type respectively to generate an independent health parameter;

using the independent health parameter to generate a comprehensive health parameter.

An embodiment of the present disclosure discloses a method for displaying vehicle health parameter, including:

receiving an obtaining request of a vehicle health parameter, the obtaining request including an vehicle identification;

extracting a corresponding independent health parameter and/or comprehensive health parameter according to the vehicle identification;

displaying the corresponding independent health parameter and/or comprehensive health parameter;

wherein,

the independent health parameter is generated by the method of:

obtaining an original vehicle data package from a vehicle cloud data server, the original vehicle data package including vehicle data, the vehicle data including data field;

determining a health parameter type which the vehicle data belongs to according to the data field;

using the vehicle data under the health parameter type respectively to generate an independent health parameter;

the comprehensive health parameter is generated by the method of:

using the independent health parameter to generate the comprehensive health parameter.

An embodiment of the present disclosure discloses a device for generating vehicle health parameter, including:

an original vehicle data package obtaining module, configured to obtain an original vehicle data package from a vehicle cloud data server; the original vehicle data package including vehicle data, the vehicle data including data field;

a health parameter type determining module, configured to determine a health parameter type which the vehicle data belongs to according to the data field;

an independent health parameter generating module, configured to use vehicle data under the health parameter type respectively to generate an independent health parameter;

a comprehensive health parameter generating module, configured to use the independent health parameter to generate the comprehensive health parameter.

An embodiment of the present disclosure discloses a device for displaying vehicle health parameter, including:

an obtaining request receiving module, configured to receive obtaining request of a vehicle health parameter; the obtaining request including an vehicle identification;

a health parameter extracting module, configured to extract a corresponding independent health parameter and/or comprehensive health parameter according to the vehicle identification;

a health parameter displaying module, configured to display the corresponding independent health parameter and/or comprehensive health parameter;

wherein the device further includes:

an original vehicle data package obtaining module, configured to obtain an original vehicle data package from a vehicle cloud data server; the original vehicle data package including vehicle data, the vehicle data including data field;

a health parameter type determining module, configured to determine health parameter type which the vehicle data belongs to according to the data field;

an independent health parameter generating module, configured to use vehicle data under the health parameter type respectively to generate the independent health parameter;

a comprehensive health parameter generating module, configured to use the independent health parameter to generate the comprehensive health parameter.

An embodiment of the present disclosure discloses device for generating vehicle health parameter, including:

at least one processor;

a memory for storing at least one instruction executable by the processor;

wherein the processor is configured to:

obtain an original vehicle data package from a vehicle cloud data server; the original vehicle data package including vehicle data, the vehicle data including data field;

determine a health parameter type which the vehicle data belongs to according to the data field;

use vehicle data under the health parameter type respectively to generate an independent health parameter;

use the independent health parameter to generate the comprehensive health parameter.

An embodiment of the present disclosure discloses device for displaying vehicle health parameter, including:

at least one second processor;

a second memory for storing at least one instruction executable by the second processor;

wherein the second processor is configured to:

receive obtaining request of a vehicle health parameter; the obtaining request comprising a vehicle identification;

extract a corresponding independent health parameter and/or comprehensive health parameter according to the vehicle identification;

display the corresponding independent health parameter and/or comprehensive health parameter;

obtain an original vehicle data package from a vehicle cloud data server; the original vehicle data package comprising vehicle data, the vehicle data comprising data field;

determine health parameter type which the vehicle data belongs to according to the data field;

use vehicle data under the health parameter type respectively to generate the independent health parameter;

use the independent health parameter to generate the comprehensive health parameter.

In the method for generating a vehicle health parameter and the device thereof, and a method for displaying a vehicle health parameter and the device thereof, a cloud platform stores vehicle data uploaded by a vehicle-mounted terminal apparatus, in the embodiment of the present disclosure, original vehicle data package may be obtained from the vehicle cloud data server, and generate independent health parameter corresponding to the health parameter type according to the original vehicle data package, the independent health parameter may be evaluation score which reflects vehicle health state in performance, safety and other single aspects, furthermore, in the embodiment of the present disclosure, a comprehensive health parameter may be further generated according to the independent health parameter, the comprehensive health parameter may be an evaluation score which reflects vehicle comprehensive health state such as performance and safety, the independent health parameter and the comprehensive health parameter may reflect vehicle health state objectively and accurately, which is significant in practical usage.

In the embodiment of the present disclosure, when the user needs to check the health state of the vehicle, he or she may send the obtaining request to the vehicle cloud data server, the vehicle cloud data server may extract corresponding independent health parameter and/or comprehensive health parameter according to the vehicle identification to feed back to the user.

Besides, in the embodiment of the present disclosure, it is also capable to sort the vehicles with same vehicle type according to the independent health parameter and/or the comprehensive health parameter, the user may know the practical situation of the vehicle directly according to the sorting result of the independent health parameter and/or the comprehensive health parameter, which brings best user experience effect.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow chart showing the method for generating vehicle health parameter according to an embodiment of the present disclosure;

FIG. 2 is a schematic diagram showing a vehicle-mounted terminal apparatus uploading vehicle data according to an embodiment of the present disclosure.

FIG. 3 is a flow chart showing the method for displaying vehicle health parameter according to an embodiment of the present disclosure;

FIG. 4 is a schematic diagram showing an evaluation process to a vehicle health state in an embodiment of the present disclosure.

FIG. 5 is a schematic diagram showing an evaluation process to a vehicle health state in another embodiment of the present disclosure.

FIG. 6 is a block diagram showing the structure of a device for generating a vehicle health parameter in an embodiment of the present disclosure.

FIG. 7 is a block diagram showing the structure of a device for displaying a vehicle health parameter in an embodiment of the present disclosure.

FIG. 8 is a block diagram schematically showing the device for generating a vehicle health parameter according to the present disclosure.

FIG. 9 is a schematic diagram showing a memory for saving or carrying instructions according to the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

Currently, a user evaluates vehicles health state mainly by the following ways:

### (1) Vehicle Basic Information Evaluation

Basic new rate of vehicle is determined according to the basic information of vehicle. Wherein, basic information of vehicle includes: total kilometres, vehicle age, vehicle maintenance record and the like.

### (2) Vehicle Interior and Appearance

Conditions of vehicle interior and appearance are observed by naked eyes, checking whether the interior of vehicle is clean and tidy, whether parts are replaced, checking whether exterior of vehicle has damage trace, whether parts are replaced, whether there is metal plate processing, where the aging condition of paint is in accordance with vehicle age. A subjective determination is performed according to the observation result.

### (3) Test Drive

The user experiences vehicle vibration frequency and magnitude, noise level, sealing performance, vehicle dynamic performance, braking performance, shifting performance by test driving.

However, above vehicle health evaluation ways are too subjective. It is difficult for a user who is not familiar with vehicle technology to accurate determine the real condition of vehicle. Besides, there is severe information asymmetry between sellers and buyers, assuming there is no effective supervisor, or a used vehicle seller does not sufficiently fear the adverse consequences of cheating, a used vehicle seller is likely to hide the unflattering information intentionally under the motivation of profit, in order to get a better price.

In addition, even a specialist cannot detect a sub-healthy state of a vehicle which is not apparent within a short time. For example, the sub-healthy state may be the oil consumption of vehicle under long distance driving, operating state of vehicle engine, performance of different gears in different ranges of vehicle, vehicle emission standard, information such as diagnostic code stored in the controller of vehicle interior and so on. It should be understood that, these vehicle conditions are not easy to be known by people, or even if known, a non specialist is still unable to judge the actual healthy state of the vehicle easily.

Concerning this, the inventor of the application discloses one of core conception of an embodiment of the present disclosure, a method for generating a vehicle health parameter and a method for displaying a vehicle health parameter are disclosed, by the original vehicle data package uploaded to the vehicle cloud data server, independent health parameter corresponding to each health parameter type of vehicle is obtained, and obtaining comprehensive health parameter according to each independent health parameter and feed back to the user, to make the user know actual healthy condition of the vehicle well.

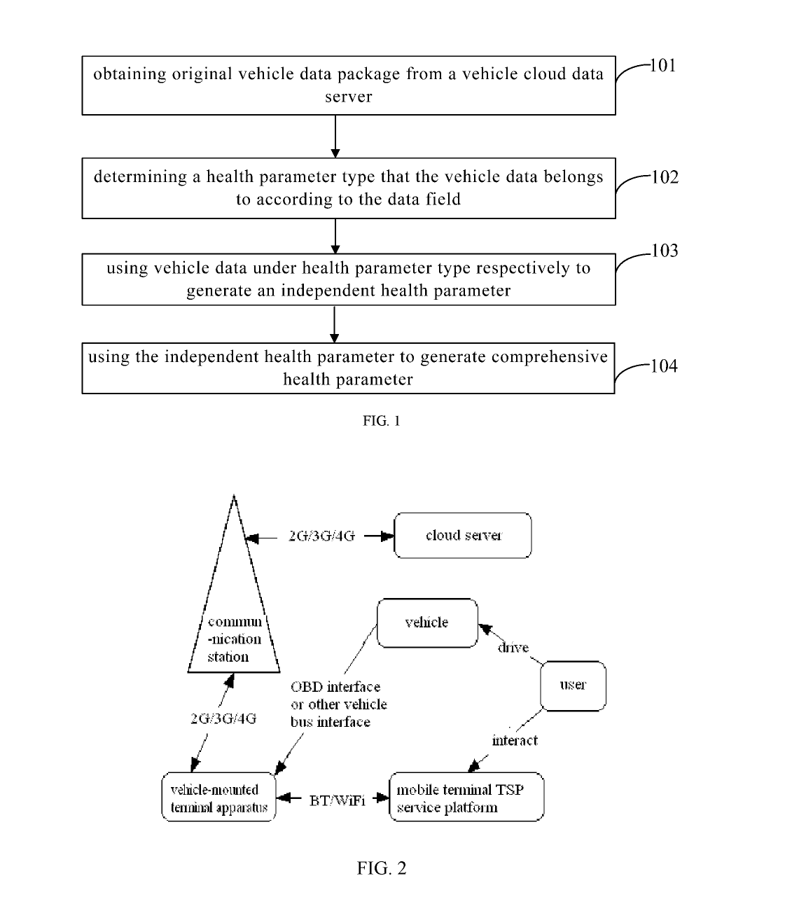

Referring to FIG. 1, which is a flow chart showing the method for generating vehicle health parameter according to an embodiment of the present disclosure, steps as follows are included:

Step 101, obtaining original vehicle data package from a vehicle cloud data server; the original vehicle data package including vehicle data, the vehicle data including data field;

during concrete realization, a vehicle-mounted terminal apparatus is usually disposed on vehicles, which may upload related vehicle data of vehicle to cloud platform via communication base station. The vehicle-mounted terminal apparatus may include OBD (On-Board Diagnostic) products, vehicle mounted T-BOX products and other apparatus which may have wireless communication functions.

Referring to FIG. 2, it is a schematic diagram showing a vehicle-mounted terminal apparatus uploading vehicle data according to an embodiment of the present disclosure. The cloud platform includes a cloud server, the vehicle-mounted terminal apparatus includes 2G/3G/4G or BT/WiFi communication modules which may communicate with the cloud server (vehicle server) wirelessly.

When the vehicle-mounted terminal apparatus on the vehicle works, the vehicle-mounted terminal apparatus may obtain vehicle data via OBD interface or other vehicle bus interface, then it uses 2G/3G/4G communication module to upload the vehicle data of the vehicle-mounted bus network, uses BT/WiFi communication network to upload the user interact vehicle data on the mobile-terminal TSP (Telematics Service Provider) service platform to the specified vehicle server address under the cloud platform via communication base station.

Step 102, determining a health parameter type that the vehicle data belongs to according to the data field;

In a preferred embodiment of the present disclosure, evaluation aspects of vehicle heath state may be: green, economic, safe, performance and fault. These evaluation aspects may be reflected by corresponding health parameter type respectively.

Detailedly, the health parameters of green, economic, safe, performance and fault aspects correspond to different health parameter types, respectively, they are green health parameter type, economic health parameter type, safe health parameter type, performance health parameter type and fault health parameter type.

It should be illustrated that, during implementing the embodiment of the present disclosure, the evaluation aspects may be increased or decreased according to actual situation. The embodiment of the present disclosure is not limited thereto.

In a preferred embodiment, step 102 may includes sub-steps of:

sub-step S11, dismantling vehicle data from an original vehicle data package;

sub-step S12, determining whether data field of the vehicle data is data field needed by a certain health parameter type or health parameter types; if yes, sub-step S13 is performed;

sub-step S13, classifying the vehicle data corresponding to the data field to the certain health parameter type or health parameter types.

In the embodiment of the present disclosure, the vehicle data uploaded to the cloud vehicle data server is dismantled, classified, extracted and organized, then the data is input to preset vehicle health evaluation model to calculate a vehicle health parameter which is capable of evaluating vehicle health state.

In an embodiment of the present disclosure, each evaluation aspect of green, economic, safe, performance and fault corresponds to a vehicle health evaluation model. When it is needed to evaluate the health state of one or more aspect of the vehicle, it is capable to extract vehicle data which is valuable to the vehicle health evaluation model from the original vehicle data package according to the requirement of the vehicle health evaluation model.

For example, the information “vehicle speed” may be used to extract the parameters such as: “number of acceleration times”, “number of deceleration times”, “number of overspeed times”. In the embodiment of the present disclosure, the health parameter type that the vehicle data belongs to needs to be determined, in order to input the vehicle data to the corresponding vehicle health evaluation model to calculate the independent health parameter.

It should be illustrated that, in practical, the vehicle data may belong to one health parameter type, and it may also belong to a plurality of health parameter types, the embodiment of the present disclosure is not limited thereto.

For example, the vehicle data including data field of “vehicle speed” may be classified as green and safe aspects at the same time, vehicle data including data field of “average oil consumption” is classified as safe and economic evaluation aspects at the same time, the vehicle data including data field of “average pollution emission” may be classified as green aspect, vehicle data including data field of “average acceleration time per 100 kilometres” is classified as performance evaluation aspect, vehicle data including data field of “fault code” is classified as fault evaluation aspect.

In practical usage, the vehicle data is usually transmitted by binary code format. After classification of the vehicle data, the vehicle data needs to be parsed according to reservation protocols to transform ciphertext to plaintext.

Step 103, using vehicle data under health parameter type respectively to generate an independent health parameter;

In a preferred embodiment of the present disclosure, step 103 may include sub-steps of:

Sub-step S31, comparing the vehicle data under the health parameter type with a preset target value respectively to obtain an independent parameter;

Sub-step S32, using the independent parameter and corresponding first weight to determine the independent health parameter, the first weight being an importance degree value of the independent parameter when determining the independent health parameter.

In an embodiment of the present disclosure, the vehicle data whose health parameter type is determined is input to corresponding vehicle health evaluation model to calculate the vehicle health parameter, the vehicle data at that moment may be called model input data. In the embodiment of the present disclosure, before the model input data is input to the model, it is compared with a specific target value to obtain each model input data, that is the independent parameter corresponding to each vehicle data. The independent parameter is the evaluation score specific to each vehicle data.

To be easily understood, taking the oil consumption per 100 kilometres as an example, assuming the factory default value of certain vehicle type is 6.7 L/100 km, which is actual measured oil consumption, when actual estimated value is less than or equal to 6.7, the score is full. When the actual estimate value is larger than 6.7, the score should be reduced correspondingly, when the actual estimated value is twice of the factory default value (13.2), the score is zero. For example, actual estimated value 6 corresponds to the score 100, actual estimated value 8 corresponds to the score 80.1, actual estimated value 14 corresponds to the score 0.

When calculating independent parameter corresponding to each vehicle data, the independent parameter may be input to corresponding vehicle health evaluation model to obtain vehicle health parameter.

Wherein, weight is a relative concept, which aims at certain index. Weight of certain index means the relative important degree of the index when giving an overall evaluation to something. In an embodiment of the present disclosure, the weight is used to indicate the importance degree of each parameter when calculating the vehicle health parameter. The value of the weight may be set according to actual requirement, the embodiment of the present disclosure is not limited.

In an embodiment of the present disclosure, the vehicle health parameter may include independent health parameters. Detailedly, the independent health parameter may reflect vehicle health states on the aspects of green, economic, safe, performance and fault.

Specific to green evaluation aspect, data extracted from the cloud platform such as vehicle pollutant emissions data state, vehicle carbon emissions data, vehicle oil consumption data, vehicle sharing rate are weighted and processed, the weight of each part may be adjusted manually or automatically according to different emphasized aspect of green score evaluation.

Specific to economic evaluation aspect, data extracted from the cloud platform such as vehicle oil consumption rate, vehicle maintenance consumption record, vehicle violation penalty record are weighted and processed, the weight of each part may be adjusted manually or automatically according to different emphasized aspect of economic score evaluation.

Specific to safe evaluation aspect, data extracted from the cloud platform such as accumulated fatigue driving data, accumulated tire pressure data, braking system state and history usage frequency, driving behavior data are weighted and processed, the weight of each part may be adjusted manually or automatically according to different emphasized aspect of safe score evaluation. Wherein, if tire parameter and braking parameter excess certain threshold value, the evaluation score may be set as zero directly, the weighting process is failed.

Specific to performance evaluation aspect, data extracted from the cloud platform such as acceleration per 100 kilogram data, gear shift rule during acceleration and deceleration, accumulation state of engine combustion are weighted and processed, the weight of each part may be adjusted manually or automatically according to different emphasized aspect of performance score evaluation.

Specific to fault evaluation aspect, data extracted from the cloud platform such as all vehicle fault code are weighted and processed, the weight of each part may be adjusted manually or automatically according to different emphasized aspect of fault score evaluation. The fault codes are divided into four types, which are driving safety related fault, vehicle safety related fault, vehicle performance related fault, capable-of-directly-delete fault.

To make a skilled person in the art better understand the embodiment of the present disclosure, to take the green evaluation part as an example, the process of calculating the independent health parameter in the embodiment of the present disclosure is illustrated. Data extracted from the cloud platform such as vehicle pollutant emissions data state, vehicle carbon emissions data, vehicle oil consumption data, vehicle sharing rate are weighted and processed, the weight of each part may be adjusted manually or automatically according to different emphasized aspect of green score evaluation. The formula for calculating the independent health parameter of the green evaluation aspect is shown in formula 1.

S_{Gre}=W_{GrePE}P_{GrePE}+W_{GreFQ}P_{GreFQ}+W_{GreCE}P_{GreCE}+W_{GreUR}P_{GreUR} formula 1

Wherein SGre is green evaluation score (that is independent health parameter in the green evaluation aspect), W represents weight of each aspect, P represents score of each grade item in green evaluation, GrePE represents pollution emission part in the green evaluation, GreFQ represents oil consumption part in green evaluation, GreCE represents carbon emission part in green evaluation, GreUR represents vehicle sharing rate part of green evaluation.

Since the way of calculating independent health parameters in economic, safe, performance, fault aspects are similar as that in green evaluation, they are not illustrated for concise purpose.

Step 104, using the independent health parameter to generate comprehensive health parameter.

In a preferred embodiment of the present disclosure, step 104 may be the sub-steps of:

sub-step S31, using the independent health parameter and corresponding second weight to determine the comprehensive health parameter; the second weight being importance degree value of the independent parameter when determining the comprehensive health parameter.

In an embodiment of the present disclosure, the comprehensive health parameter specific to vehicle may be obtained based on the above evaluation aspects by weighting. The comprehensive health parameter compared with the independent health parameter can reflect health state of the vehicle comprehensively. Detailedly, the weight of each evaluation aspect may be adjusted manually or automatically according to emphasized aspects of vehicle health state evaluation. The comprehensive health parameter of vehicle may be calculated by formula 2 as below:

S_{Tot}S +W_{Gre}S_{Gre}+W_{Eco}S_{Eco}+W_{Saf}S_{Saf}+W_{Per}S_{Per}+W_{Dig}S_{Dig} formula 2

Wherein, STot is the totally score obtained in evaluation (that is the comprehensive health parameter of the vehicle), W represents weight of each aspect, Gre represents green evaluation aspect, Eco represents economic evaluation aspect, Saf represents safe evaluation aspect, Pre represents performance evaluation aspect, Dig represents fault evaluation aspect.

It should be illustrated that, in the embodiment of the present disclosure, the independent health parameter and comprehensive health parameter of vehicle may also be calculated by other formulas, the present disclosure is not limited to the embodiment.

According to the embodiment of the present disclosure, firstly, the original vehicle data package may be obtained from the vehicle cloud data server, then the independent health parameter corresponding to each health parameter type may be generated according to the original vehicle data package, the independent health parameter may be evaluation score for reflecting a single aspect such as performance, safe of the vehicle. Furthermore, in an embodiment of the present disclosure, the comprehensive health parameter may be further generated according to the independent health parameter. The comprehensive health parameter may be an evaluation score for reflecting comprehensive health state such as performance, safe of vehicle. The independent health parameter and comprehensive health parameter may objectively reflect health state of vehicle, and cannot be controlled by man's will, having great significance.

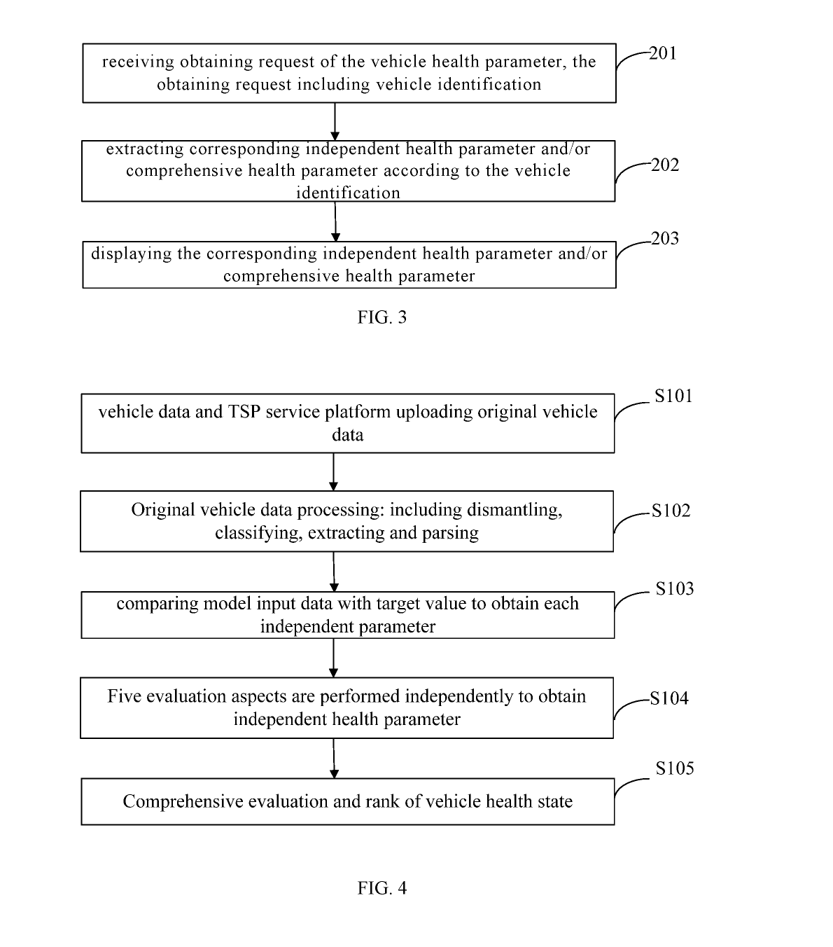

Referring to FIG. 3, it is a flow chart showing the method for displaying vehicle health parameter according to an embodiment of the present disclosure; the method may include the following steps:

step 201, receiving obtaining request of the vehicle health parameter, the obtaining request including vehicle identification;

step 202, extracting corresponding independent health parameter and/or comprehensive health parameter according to the vehicle identification;

step 203, displaying the corresponding independent health parameter and/or comprehensive health parameter;

In a preferred embodiment of the present disclosure, the vehicle identification may correspond to a vehicle type, the method may further include sub-steps of:

determine the vehicle type corresponding to the vehicle identification;

obtaining comprehensive health parameter and/or independent health parameter corresponding to other vehicle identification having same vehicle type;

sorting comprehensive health parameter and/or the independent health parameter of the vehicle and outputting the sorting result.

Wherein,

the independent health parameter is generated by the method of:

obtaining an original vehicle data package from a vehicle cloud data server, the original vehicle data package including vehicle data, the vehicle data including data field;

determining a health parameter type that the vehicle data belongs to according to the data field;

using the vehicle data under the health parameter type respectively to generate an independent health parameter;

the comprehensive health parameter may be generated by the method of:

using the independent health parameter to generate the comprehensive health parameter.

Since the embodiment of generating independent health parameter and comprehensive health parameter in the method embodiment is basically similar with the embodiment of above method, the non-detail description about generating independent health parameter and comprehensive health parameter may refer to relative description of the previous embodiment, which is not illustrated herein for concise.

In a preferred embodiment of the present disclosure, the vehicle identification corresponds to a vehicle type, the method may further include steps of:

determining vehicle type corresponding to the vehicle identification;

obtaining comprehensive health parameter and/or independent health parameter corresponding to other vehicle identification having same vehicle type;

sorting comprehensive health parameter and/or the independent health parameter of the vehicle and outputting the sorting result.

In the embodiment of the present disclosure, the vehicle evaluation result is obtained according to the vehicle health evaluation model, that is, the independent health parameter and the comprehensive health parameter of the vehicle, it is also capable to sort the independent health parameter and comprehensive health parameter of the same vehicle type, thusly allows the user to directly know the actual health state of the vehicle. Especially for a non-professional user, sometimes it is hard to understand the real meaning of vehicle data, he or she may be clear by means of sorting, which brings best experiencing effect. Particularly, frame number or license plate number of vehicle may be used as a unique identification of the vehicle data uploaded in the database.

For example, to all owners of certain type vehicles, an overall ranking may be obtained according to total score (comprehensive health parameter), mobile phone APP may display top 10 talent owners. Obviously, it is also capable of sorting each evaluation aspect, such as top 10 green environment protecting talent owner, top 10 safe owner, top 10 sharing talent owners.

The current situation is, because of information asymmetrical, used vehicle market is more complex than new vehicle market. However, as the continuous expansion of vehicle market, the used vehicle market expands continuously therewith. If the used vehicle can be evaluated accurately and objectively, the user will pay more trust on used vehicles. If a vehicle is registered and tracked in information at the beginning, a user may know related information about the vehicle comprehensively, the used vehicle market will be expanded larger, and practical prospect is promising.

In addition, besides strong demand to vehicle health state in used vehicle market, the ordinary user may know the “sickness” or “sub-healthy” state of his or her vehicle which cannot be found by naked eyes at any time. As a result, the embodiment of the present disclosure has great significance to evaluate health state of vehicle.

To make a skilled person in the art to better understand the embodiment of the present disclosure, the method for generating the vehicle health parameter and the method for displaying the vehicle health parameter in the embodiment of the present disclosure are illustrated hereinafter.

FIG. 4 is a schematic diagram showing an evaluation process to a vehicle health state in an embodiment of the present disclosure. The process may be divided as follows:

step S101, when the vehicle-mounted terminal apparatus operates, a communication module on the vehicle-mounted terminal apparatus uploads the data on the vehicle-mounted bus network and the user interact vehicle data on the TSP service platform to address of specified cloud platform server via the communication base station, which may be seen at FIG. 2;

step S102, the cloud platform performs dismantling, classifying, parsing and other processes to the uploaded vehicle data. That is, it organizes the original vehicle data, and input extracts vehicle data needed by each vehicle health evaluation model (the vehicle data herein is called model input data).

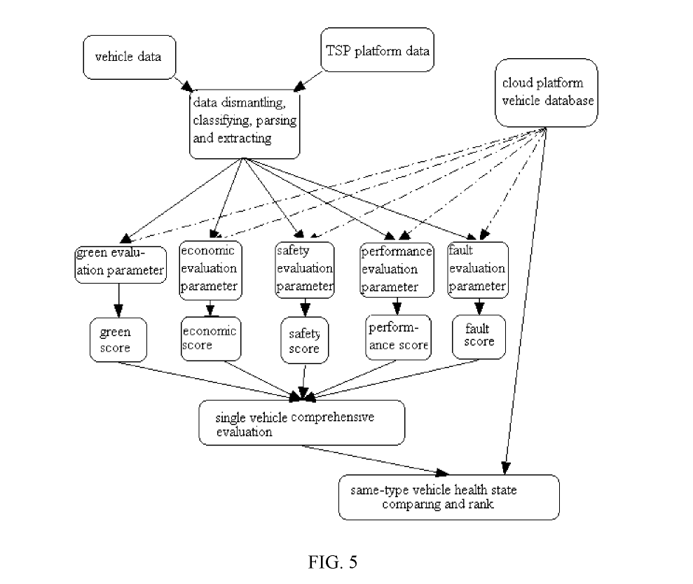

Step S103, comparing the obtained model input data with target value in the cloud platform database, thusly obtaining the independent parameter specific to each vehicle data. The detailed description may refer to FIG. 5, which is a schematic diagram showing an evaluation process to a vehicle health state in another embodiment of the present disclosure.

Wherein, to the independent parameter of each vehicle data attending vehicle health evaluation model, the cloud platform database is provided with specific target values. Most of these target values may be determined by searching in the vehicle type database, that is, the target values are different according to different vehicle brands, vehicle types, vehicle configurations, such as target oil consumption, target braking distance and so on. The other parts of target values are determined according to experience or relative decree-limited values, such as number of quick accelerating times, periodical maintenance charge, target emission index and so on. Obviously, the target value may also be set according to other methods, the embodiment of the present disclosure is not limited.

Step S104, each evaluation aspect of the vehicle independently evaluate the score to the aspects according to their concerned vehicle data. By this step, evaluation results in five aspect namely green, economic, safe, performance, fault are obtained, which are the independent health parameters of each evaluation aspects, which may also refer to FIG. 5.

Step S105, according to the output result of each evaluation result, calculating a vehicle comprehensive evaluation result by weighting, which is the comprehensive health parameter. Furthermore, in the embodiment of the present disclosure, the vehicle health parameters of all network-connected vehicles having the same type are compared, and sorting is performed according to the comprehensive evaluation result and the score of each evaluation aspect. The result may be comprehensive ranking, green ranking, economic ranking, safety ranking, performance ranking, fault venture ranking, which may also be referred to FIG. 5.

In an embodiment of the present disclosure, according to different types of vehicles, it is capable to extract the ranking result according to number value of each vehicle health parameter for example, the independent health parameter after green evaluation is sorted by value to obtain green ranking, and display it to the user, and/or, the independent health parameter after economic evaluation is sorted by value to obtain economic ranking, and display it to the user, and/or, the independent health parameter after safe evaluation is sorted by value to obtain safe ranking, and display it to the user, and/or, the independent health parameter after performance evaluation is sorted by value to obtain performance ranking, and display it to the user, and/or, the independent health parameter after fault evaluation is sorted by value to obtain fault ranking, and display it to the user, and/or, the comprehensive health parameter is sorted by value to obtain the comprehensive ranking and display it to the user.

Obviously, to avoid occupying overlarge screen, it is also capable of displaying top vehicle health parameters for the user. What needs to be illustrated is, in implementing the embodiment of the present disclosure, vehicles having different types may also be sorted to obtain sorting result, and vehicle health parameters within certain time period may be extracted to be sorted, and the embodiment of the present disclosure is not limited thereto.

The independent health parameter in the embodiment of the present disclosure is generated by inputting vehicle data to corresponding vehicle health evaluation model according to data field, which may be used to represent objective evaluation score in green, economic, safe, performance, fault and other aspects and may show the health state of the vehicle. Furthermore, it is also capable to obtain evaluation score reflecting vehicle comprehensive state according to the independent health parameter, that is the comprehensive health parameter is used to reflect the comprehensive health state of vehicle.

Detailedly, the independent health parameter of the green evaluation aspect includes vehicle data such as vehicle pollutant emissions data state, vehicle carbon emissions data, vehicle oil consumption data, vehicle sharing rate, or mainly calculated by vehicle data such as vehicle pollutant emissions data state, vehicle carbon emissions data, vehicle oil consumption data, vehicle sharing rate, the calculating way may be performed by weighted average to the data. The independent health parameter of economic evaluation aspect may include vehicle data such as vehicle oil consumption rate, vehicle maintenance consumption record, vehicle violation penalty record, or mainly calculated by vehicle data such as vehicle oil consumption rate, vehicle maintenance consumption record, vehicle violation penalty record, the calculating way may be performing weighted average to the data. The independent health parameter of the safe evaluation aspect may include vehicle data such as accumulated fatigue driving data, accumulated tire pressure data, braking system state and history usage frequency, driving behavior data, or mainly calculated by vehicle data such as accumulated fatigue driving data, accumulated tire pressure data, braking system state and history usage frequency, driving behavior data, the calculating way may be performing weighted average to the data. The independent health parameter of the fault evaluation aspect may include vehicle data such as acceleration per 100 kilogram data, gear shift rule during acceleration and deceleration, accumulation state of engine combustion, or mainly calculated by vehicle data such as acceleration per 100 kilogram data, gear shift rule during acceleration and deceleration, accumulation state of engine combustion, the calculating way may be performing weighted average to the data. The comprehensive health parameter may be obtained by calculating independent health parameter in green, economic, safe, performance, fault aspects, the calculating way may be performing weighted average to each evaluation aspects.

For example, to a specific vehicle, if the scores are evaluated on the aspects of green, economic, safe, performance and fault, the obtained independent health parameters are 90, 80, 75, 60 and 90. The vehicle is further evaluated as a whole to get comprehensive score to obtain the overall score in comprehensive aspects, the obtained comprehensive health parameter may be 80.

It should be noted that, the evaluation score is only an example, during implementing the embodiment of the present disclosure, the evaluation result may also be represented by other means according to actual situation, the embodiment of the present disclosure is not limited thereto.

In the embodiment of the present disclosure, when the user needs to examine the health state of the vehicle, he or she may send obtaining request to the vehicle cloud data server, the vehicle cloud data server may extract independent health parameter and/or comprehensive health parameter according to the vehicle identification of the request to feedback to the user.

Besides, in the embodiment of the present disclosure, the sort may be performed by the independent health parameter and/or the comprehensive health parameter according to same vehicle type of vehicle, according to the sorting result of the independent health parameter and/or comprehensive health parameter, the user may directly obtain the actual situation of vehicle, which has best experience effect.

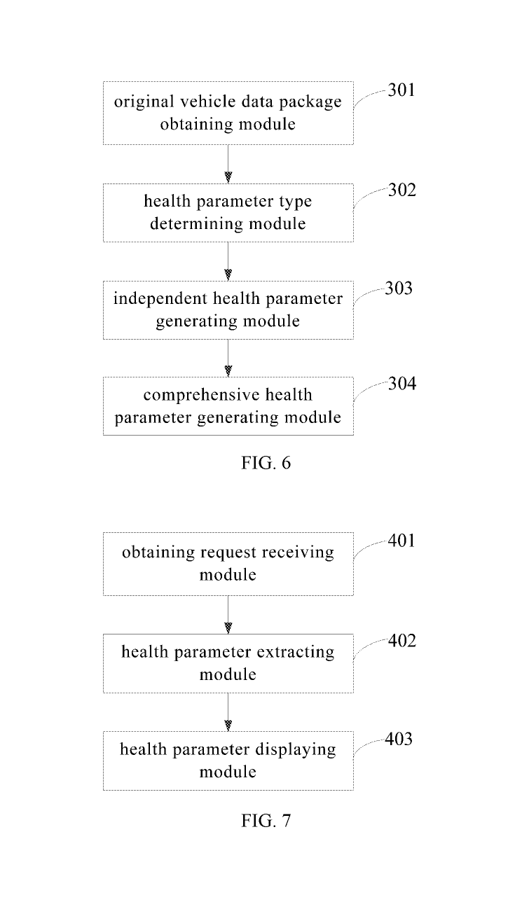

Referring to FIG. 6, it is a structural block diagram showing a device for generating a vehicle health parameter in an embodiment of the present disclosure. The device may include the following modules:

an original vehicle data package obtaining module 301, configured to obtain original vehicle data package from a vehicle cloud data server; the original vehicle data package including vehicle data, the vehicle data including data field;

a health parameter type determining module 302, configured to determine health parameter type which the vehicle data belongs to according to the data field;

in an embodiment of the present disclosure, the health parameter type determining module 302 may include sub-modules of:

a vehicle data dismantling sub-module, configured to dismantle vehicle data from the original vehicle data package;

a data field judging sub-module, configured to determine whether data field of the vehicle data is data field needed by a certain health parameter type or health parameter types, if yes, invoking a health parameter type classifying sub-module;

a health parameter type classifying sub-module, configured to classify vehicle data corresponding to the data field to the certain health parameter type or health parameter types.

an independent health parameter generating module 303, configured to use vehicle data under the health parameter type to generate independent health parameter;

in an embodiment of the present disclosure, the independent health parameter generating module 303 may be the following sub-modules:

an independent parameter calculating sub-module, configured to compare the vehicle data under the health parameter type with the preset target value respectively to obtain an independent parameter.

an independent health parameter calculating sub-module, configured to use the independent parameter and corresponding first weight to determine the independent health parameter; the first weight is an importance degree value when the independent parameter determines the independent health parameter.

a comprehensive health parameter generating module 304, configured to use the independent health parameter to generate the comprehensive health parameter.

In a preferred embodiment of the present disclosure, the comprehensive health parameter generating module 304 may include the following sub-modules:

a comprehensive health parameter calculating sub-module, configured to use the independent health parameter and corresponding second weight to determine comprehensive health parameter; the second weight being importance degree value when the independent parameter determines the comprehensive health parameter.

In a preferred embodiment of the present disclosure, the health parameter type may include a green health parameter type, an economic health parameter type, a safe health parameter type, a performance health parameter type and a fault health parameter type.

To the embodiment about the device in FIG. 6, since it is similar as the above embodiment, the illustration is concise, the related part can be referred to the embodiment about the method.

Referring to FIG. 7, it is a block diagram showing the structure of a device for displaying a vehicle health parameter in an embodiment of the present disclosure. The device may include the modules as follows:

an obtaining request receiving module 401, configured to receive obtaining request of a vehicle health parameter; the obtaining request includes an vehicle identification;

a health parameter extracting module 402, configured to extract independent health parameter and/or comprehensive health parameter according to the vehicle identification;

a health parameter displaying module 403, configured to display the corresponding independent health parameter and/or comprehensive health parameter;

wherein the device further includes:

an original vehicle data package obtaining module, configured to obtain original vehicle data package from a vehicle cloud data server; the original vehicle data package including vehicle data, the vehicle data including data field;

a health parameter type determining module, configured to determine health parameter type which the vehicle data belongs to according to the data field;

an independent health parameter generating module, configured to use vehicle data under the health parameter type respectively to generate independent health parameter;

a comprehensive health parameter generating module, configured to use the independent health parameter to generate the comprehensive health parameter.

In a preferred embodiment of the present disclosure, the vehicle identification may have corresponding vehicle type, the device further includes:

a vehicle type determining module, configured to determine vehicle type corresponding to the vehicle identification;

a health parameter obtaining module, configured to obtain comprehensive health parameter and/or the independent health parameter corresponding to other vehicle identification which is the same as the vehicle type;

a health parameter sorting module, configured to sort according to comprehensive health parameter and/or the independent health parameter of vehicle, and outputting the sorting result.

To device embodiment in FIG. 7, since it is similar to the method embodiment above, the description is concise, the related part may refer to the illustration to the method embodiment.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the apparatus for recognizing advertisement plug-ins according to the embodiments of the present disclosure. The present disclosure may be further realized as some or all the equipments or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

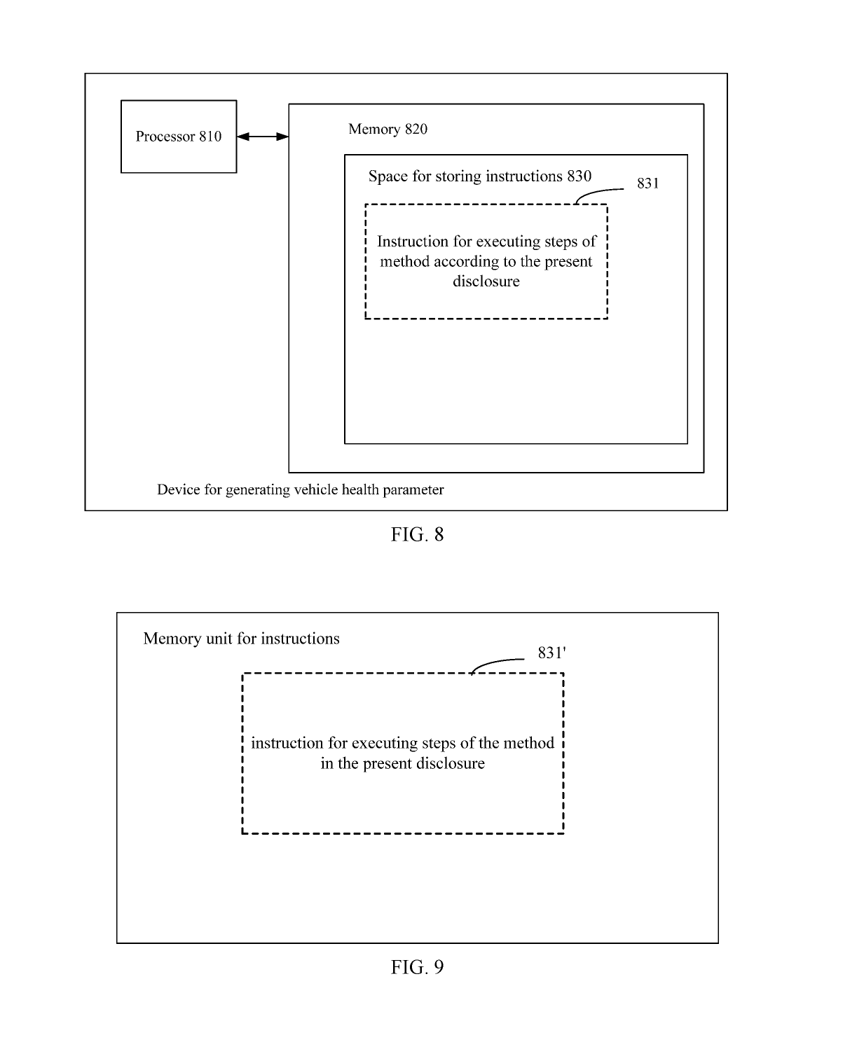

For example, FIG. 8 is a block diagram schematically showing a device for generating vehicle health parameter of the present disclosure. The device conventionally includes a processor 810 and a computer program product or computer readable medium in the form of memory 820. The memory 820 may be an electronic memory such as a flash memory, EEPRPOM (electrically erasable programmable read-only memory), EPROM (electrically programmable read-only memory), hard disk or ROM (read-only memory). The memory 820 has a memory space 830 for storing instructions for executing any of the steps in the above method. For example, the memory space 830 for storing the instructions may include each instruction 831 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 9. The memory unit may have similar-arranged memory paragraph, memory space and the like as the memory 820 of the device for controlling the operation of in-vehicle infotainment in FIG. 8. The instructions may be, for example, compacted in appropriate form. Generally, the memory unit includes a computer readable code 831′, that is, the code which may be read by processor such as the processor 810. When the instruction is executed by the device for controlling the operation of in-vehicle infotainment, the device is made to execute the steps in the methods above.

The device embodiment is described above merely for a schematic purpose, wherein the units explained as individual members may or may not be physically separated, the members shown as units may or may not be physical units and they can be located in a place or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the illustrative not limiting purpose of the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A method for generating vehicle health parameter, comprising:
obtaining an original vehicle data package from a vehicle cloud data server, the original vehicle data package comprising vehicle data, the vehicle data comprising data field;
determining a health parameter type which the vehicle data belongs to according to the data field;
using the vehicle data under the health parameter type respectively to generate an independent health parameter;
using the independent health parameter to generate a comprehensive health parameter.

2. The method according to claim 1, wherein the step of determining the health parameter type which the vehicle data belongs to according to the data field comprises:
dismantling vehicle data from an original vehicle data package;
determining whether the data field of the vehicle data is the data field needed by a certain health parameter type or health parameter types;
if yes, classifying the vehicle data corresponding to the data field to the certain health parameter type or health parameter types.

3. The method according to claim 1, wherein the step of using the vehicle data under the health parameter type respectively to generate the independent health parameter comprises:
comparing the vehicle data under the health parameter type with a preset target value respectively to obtain the independent parameter;
using the independent parameter and a corresponding first weight to determine the independent health parameter, the first weight being an importance degree value of the independent parameter when determining the independent health parameter.

4. The method according to claim 1, wherein the step of using the independent health parameter to generate the comprehensive health parameter is:
using the independent health parameter and corresponding second weight to determine the comprehensive health parameter, the second weight being an importance degree value of the independent parameter when determining the comprehensive health parameter.

5. The method of claim 1, wherein the health parameter type comprises a green health parameter type, an economic health parameter type, a safety health parameter type, a performance health parameter type and a fault health parameter type.

6. A method for displaying vehicle health parameter, comprising:
receiving an obtaining request of a vehicle health parameter, the obtaining request comprising an vehicle identification;
extracting a corresponding independent health parameter and/or comprehensive health parameter according to the vehicle identification;
displaying the corresponding independent health parameter and/or comprehensive health parameter;
wherein,
the independent health parameter is generated by the method of:
obtaining an original vehicle data package from a vehicle cloud data server, the original vehicle data package comprising vehicle data, the vehicle data comprising data field;
determining a health parameter type which the vehicle data belongs to according to the data field;
using the vehicle data under the health parameter type respectively to generate an independent health parameter;
the comprehensive health parameter is generated by the method of:
using the independent health parameter to generate the comprehensive health parameter.

7. The method according to claim 6, wherein the vehicle identification corresponds to a vehicle type, the method further comprises:
determining the vehicle type corresponding to the vehicle identification;
obtaining a comprehensive health parameter and/or independent health parameter corresponding to other vehicle identification having same vehicle type;
sorting the comprehensive health parameter and/or the independent health parameter of the vehicle and outputting the sorting result.

8. A device for generating vehicle health parameter, comprising:
at least one first processor;
a first memory for storing at least one instruction executable by the first processor;
wherein the first processor is configured to:
obtain an original vehicle data package from a vehicle cloud data server; the original vehicle data package comprising vehicle data, the vehicle data comprising data field;
determine a health parameter type which the vehicle data belongs to according to the data field;
use vehicle data under the health parameter type respectively to generate an independent health parameter;
use the independent health parameter to generate the comprehensive health parameter.

9. The device according to claim 8, wherein the first processor is further configured to:
dismantle vehicle data from the original vehicle data package;
judge whether data field of the vehicle data is the data field needed by certain health parameter type or health parameter types, if yes, invoking a health parameter type classifying sub-module;
classify vehicle data corresponding to the data field to the certain health parameter type or health parameter types.

10. The device according to claim 8, wherein the first processor is further configured to:
compare the vehicle data under the health parameter type with the preset target value respectively to obtain an independent parameter;
use the independent parameter and corresponding first weight to determine the independent health parameter; the first weight being an importance degree value of the independent parameter when determining the independent health parameter.

11. The device according to claim 8, wherein the first processor is further configured to:
use the independent health parameter and a corresponding second weight to determine a comprehensive health parameter; the second weight being an importance degree value of the independent parameter when determining the comprehensive health parameter.

12. A device for displaying vehicle health parameter, comprising:
at least one second processor;
a second memory for storing at least one instruction executable by the second processor;
wherein the second processor is configured to:
receive obtaining request of a vehicle health parameter; the obtaining request comprising an vehicle identification;
extract a corresponding independent health parameter and/or comprehensive health parameter according to the vehicle identification;
display the corresponding independent health parameter and/or comprehensive health parameter;
obtain an original vehicle data package from a vehicle cloud data server; the original vehicle data package comprising vehicle data, the vehicle data comprising data field;
determine health parameter type which the vehicle data belongs to according to the data field;
use vehicle data under the health parameter type respectively to generate the independent health parameter;
use the independent health parameter to generate the comprehensive health parameter.

13. The device according to claim 12, wherein the vehicle identification corresponds to a vehicle type, the second processor is further configured to:
determine vehicle type corresponding to the vehicle identification;
obtain the comprehensive health parameter and/or the independent health parameter corresponding to other vehicle identification with the same vehicle type;
sort according to comprehensive health parameter and/or the independent health parameter of vehicle, and outputting the sorting result.

14. The method according to claim 2, wherein the step of using the independent health parameter to generate the comprehensive health parameter is: using the independent health parameter and corresponding second weight to determine the comprehensive health parameter, the second weight being an importance degree value of the independent parameter when determining the comprehensive health parameter.

15. The method according to claim 3, wherein the step of using the independent health parameter to generate the comprehensive health parameter is: using the independent health parameter and corresponding second weight to determine the comprehensive health parameter, the second weight being an importance degree value of the independent parameter when determining the comprehensive health parameter.

16. The method according to claim 6, wherein the vehicle identification corresponds to a vehicle type, the method further comprises:
determining the vehicle type corresponding to the vehicle identification;
obtaining a comprehensive health parameter and independent health parameter corresponding to other vehicle identification having same vehicle type;
sorting the comprehensive health parameter and the independent health parameter of the vehicle and outputting the sorting result.

17. The device according to claim 9, wherein the first processor is further configured to:
use the independent health parameter and a corresponding second weight to determine a comprehensive health parameter; the second weight being an importance degree value of the independent parameter when determining the comprehensive health parameter.

18. The device according to claim 10, wherein the first processor is further configured to:
use the independent health parameter and a corresponding second weight to determine a comprehensive health parameter; the second weight being an importance degree value of the independent parameter when determining the comprehensive health parameter.
